(19) United States
(12) Patent Application Publication
(10) Pub. No.: US 2011/0281067 A1
(43) Pub. Date: Nov. 17, 2011

(54) SURFACE PROTECTIVE FILM

(75) Inventors: Mariko YOSHIDA, Ibaraki-shi (JP); Shou UCHIDA, Ibaraki-shi (JP); Ikkou HANAKI, Ibaraki-shi (JP); Keiji HAYASHI, Ibaraki-shi (JP)

(73) Assignee: NITTO DENKO CORPORATION, Osaka (JP)

(21) Appl. No.: 13/104,400

(22) Filed: May 10, 2011

(30) Foreign Application Priority Data
May 12, 2010 (JP) 2010-110164

(51) Int. Cl. C09J 7/02; B32B 3/00

(52) U.S. Cl. 428/141

(57) ABSTRACT

Provided is a surface protective film that not only maintains its adhesion for an adherend but also shows a small change over time in rewinding force even when stored in a roll shape. The surface protective film of the present invention includes: a back surface layer; a base material layer; and a pressure-sensitive adhesive layer in the stated order, in which: the surface of the back surface layer has a ten-point average surface roughness Rz of 1.0 or more; a rewinding force A after storage at 23° C. is 1.0 N/20 mm or less; and a ratio B/A of a rewinding force B after storage at 50° C. to the rewinding force A after the storage at 23° C. is 1.0 to 2.0.

This application claims priority under 35 U.S.C. Section 119 to Japanese Patent Application No. 2010-110164 filed on May 12, 2010, which is herein incorporated by references.

### BACKGROUND OF THE INVENTION

1. Field of the Invention

The present invention relates to a surface protective film.

2. Description of the Related Art

A surface protective film is generally used for the purpose of preventing a flaw or dirt that arises at the time of the working or conveyance of a body to be protected (which may hereinafter be referred to as an “adherend”) by being attached to the body to be protected through a pressure-sensitive adhesive applied to a protective film side. Examples of the body to be protected include a metal plate, a coated steel plate, and an optical film.

An example of an embodiment in which the surface protective film is used is the following embodiment. Unevenness is formed on an adherend such as a metal plate or a coated steel plate to provide the adherend with a function, design property, or the like, and then the surface protective film is attached for the conveyance of the adherend. In addition, another example of the embodiment in which the surface protective film is used is the following embodiment. The surface protective film is attached to a flat adherend, and then unevenness is formed by press working or the like. Then, the surface protective film used as described above is peeled after the termination of the step such as the conveyance or the working.

A resin that has soft nature after having been formed into a film such as polyethylene is used as a base material for the surface protective film (Japanese Patent Application Laid-open No. 2009-166277).

However, when the surface protective film is stored in a roll shape, the exposure of the surface protective film to a high temperature during a time period ending on its attachment to an adherend causes the following problem. A pressure-sensitive adhesive layer and the back surface (back surface layer) of the base material attach to each other, and hence a rewinding (unwinding) force when the surface protective film is to be rewound upon use of the film enlarges. Accordingly, the following problem arises. A redundant force is applied to the surface protective film at the time of the rewinding of the film to elongate the film, and hence it becomes difficult for the film to follow the adherend.

### SUMMARY OF THE INVENTION

The present invention has been made to solve the above-mentioned conventional problems, and an object of the present invention is to provide a surface protective film that not only maintains its adhesion for an adherend but also shows a small change over time in rewinding force even when stored in a roll shape.

A surface protective film of the present invention is a surface protective film, including: a back surface layer; a base material layer; and a pressure-sensitive adhesive layer in the stated order, in which: the surface of the back surface layer has a ten-point average surface roughness Rz of 1.0 or more; a rewinding force A after storage at 23° C. is 1.0 N/20 mm or less; and a ratio B/A of a rewinding force B after storage at 50° C. to the rewinding force A after the storage at 23° C. is 1.0 to 2.0.

In a preferred embodiment, the surface protective film of the present invention has a rupture (fracture) elongation in each of an MD direction and a TD direction of 350% to 850%.

In a preferred embodiment, the surface protective film of the present invention has an elastic modulus in tension in each of an MD direction and a TD direction of 500 N/mm² to 900 N/mm².

In a preferred embodiment, the surface protective film of the present invention has a total of an elastic modulus in tension in an MD direction and an elastic modulus in tension in a TD direction of 270 N/mm² to 450 N/mm².

In a preferred embodiment, the above-mentioned base material layer includes at least one kind selected from the group consisting of a polymer obtained from an α-olefin having 2 to 12 carbon atoms and an ethylene-vinyl alcohol copolymer.

In a preferred embodiment, the surface of the above-mentioned back surface layer has a surface frictional force of 15 N or less.

In a preferred embodiment, the above-mentioned pressure-sensitive adhesive layer includes a styrene-based elastomer.

In a preferred embodiment, the above-mentioned pressure-sensitive adhesive layer includes a polymer obtained from an α-olefin having 2 to 12 carbon atoms.

According to the present invention, there can be provided a surface protective film that not only maintains its adhesion for an adherend but also shows a small change over time in rewinding force even when stored in a roll shape.

### BRIEF DESCRIPTION OF THE DRAWINGS

FIG. 1 is a schematic sectional view of a surface protective film according to a preferred embodiment of the present invention.

### DETAILED DESCRIPTION OF THE PREFERRED EMBODIMENTS

A. Surface Protective Film

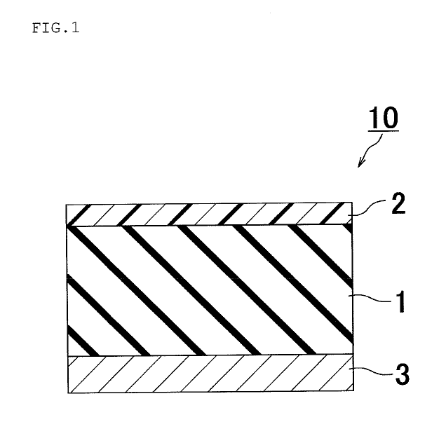

A surface protective film of the present invention has a back surface layer, a base material layer, and a pressure-sensitive adhesive layer in the stated order. FIG. 1 is a schematic sectional view of the surface protective film according to a preferred embodiment of the present invention. A surface protective film 10 includes a base material layer 1, a back surface layer 2 placed on one side of the base material layer 1, and a pressure-sensitive adhesive layer 3 placed on the other side of the base material layer 1. The surface protective film of the present invention may further have any appropriate other layer as required (not shown).

The thickness of the surface protective film of the present invention can be set to any appropriate thickness depending on applications. The thickness is preferably 10 μm to 200 μm, more preferably 15 μm to 180 μm, still more preferably 20 μm to 160 μm.

The surface protective film of the present invention has a rewinding force A after storage at 23° C. of 1.0 N/20 mm or less, preferably 0.2 N/20 mm to 1.0 N/20 mm, more preferably 0.25 N/20 mm to 1.0 N/20 mm, still more preferably 0.25 N/20 mm to 0.8 N/20 mm. As long as the rewinding force A after the storage at 23° C. falls within the above-mentioned range, the surface protective film of the present invention can satisfactorily achieve compatibility between its performance and workability because the film can be lightly rewound while its roll shape is maintained.

The surface protective film of the present invention has a rewinding force B after storage at 50° C. of 1.0 N/20 mm or less, preferably 0.2 N/20 mm to 1.0 N/20 mm, more preferably 0.25 N/20 mm to 1.0 N/20 mm, still more preferably 0.3 N/20 mm to 1.0 N/20 mm. As long as the rewinding force B after the storage at 50° C. falls within the above-mentioned range, the surface protective film of the present invention can satisfactorily achieve compatibility between its performance and workability because the film can be lightly rewound while its roll shape is maintained.

The surface protective film of the present invention has a ratio B/A of the rewinding force B after the storage at 50° C. to the rewinding force A after the storage at 23° C. of 1.0 to 2.0, preferably 1.0 to 1.9, more preferably 1.1 to 1.8. As long as the ratio B/A of the rewinding force B after the storage at 50° C. to the rewinding force A after the storage at 23° C. falls within the above-mentioned range, even when the surface protective film of the present invention is stored under a high temperature, there is neither a possibility that a peeling treatment agent that can be incorporated into the back surface layer transfers to the pressure-sensitive adhesive layer nor a possibility that the back surface layer and the pressure-sensitive adhesive layer attach to each other.

The surface protective film of the present invention has a rupture elongation in each of an MD direction and a TD direction of preferably 350% to 850%, more preferably 400% to 840%, still more preferably 500% to 830%. In the above-mentioned case, the rupture elongation in the MD direction is preferably 350% to 580%, more preferably 400% to 580%, still more preferably 450% to 550%. In addition, in the above-mentioned case, the rupture elongation in the TD direction is preferably 500% to 850%, more preferably 600% to 850%, still more preferably 700% to 850%. As long as the rupture elongation in each of the MD direction and the TD direction falls within the above-mentioned range, the surface protective film of the present invention does not rupture at the time of its attachment or working, and shows good followability for an adherend.

It should be noted that the term “MD direction” as used herein is also referred to as a “lengthwise direction,” and means the direction in which the film is conveyed at the time of the forming of the film. In addition, the term “TD direction” as used herein is also referred to as a “widthwise direction,” and means the direction perpendicular to the “MD direction.”

In a preferred embodiment, the surface protective film of the present invention has an elastic modulus in tension in each of the MD direction and the TD direction of preferably 500 N/mm² to 900 N/mm², more preferably 600 N/mm² to 850 N/mm². As long as the elastic modulus in tension in each of the MD direction and the TD direction falls within the above-mentioned range, the surface protective film of the present invention has stiffness and is excellent in workability.

In another preferred embodiment, the surface protective film of the present invention has a total of the elastic modulus in tension in the MD direction and the elastic modulus in tension in the TD direction of preferably 270 N/mm² to 450 N/mm², more preferably 300 N/mm² to 430 N/mm², still more preferably 300 N/mm² to 390 N/mm². In the above-mentioned case, the elastic modulus in tension in the MD direction is preferably 120 N/mm² to 220 N/mm², more preferably 130 N/mm² to 200 N/mm². In addition, in the above-mentioned case, the elastic modulus in tension in the TD direction is preferably 150 N/mm² to 220 N/mm², more preferably 180 N/mm² to 200 N/mm². As long as the total of the elastic modulus in tension in the MD direction and the elastic modulus in tension in the TD direction falls within the above-mentioned range, the surface protective film of the present invention shows good followability for an adherend, and can be easily worked after its attachment.

A-1. Base Material Layer

Any appropriate thickness can be adopted as the thickness of the above-mentioned base material layer depending on applications. The thickness of the above-mentioned base material layer is preferably 10 μm to 150 μm, more preferably 30 μm to 140 μm, still more preferably 60 μm to 130 μm, particularly preferably 80 μm to 120 μm.

The above-mentioned base material layer preferably includes at least one kind selected from a polymer obtained from an α-olefin having 2 to 12 carbon atoms and an ethylene-vinyl alcohol copolymer. Only one kind of the polymers each obtained from the α-olefin having 2 to 12 carbon atoms may be used, or a mixture of two or more kinds thereof may be used. The content of the at least one kind selected from the polymer obtained from the α-olefin having 2 to 12 carbon atoms and the ethylene-vinyl alcohol copolymer in the above-mentioned base material layer is preferably 80 wt % to 100 wt %, more preferably 90 wt % to 100 wt %, still more preferably 95 wt % to 100 wt %, particularly preferably 98 wt % to 100 wt %, most preferably 100 wt %.

Examples of the polymer obtained from the α-olefin having 2 to 12 carbon atoms include a homopolymer and a copolymer each obtained by polymerizing at least one kind of α-olefin having 2 to 12 carbon atoms such as ethylene, propylene, or butene. The polymer obtained from the α-olefin having 2 to 12 carbon atoms is preferably polyethylene or polypropylene, more preferably polyethylene. Any appropriate polyethylene can be adopted as the polyethylene. For example, there are given a low-density polyethylene (LDPE), a linear, low-density polyethylene (LLDPE), a medium-density polyethylene, and a high-density polyethylene (HDPE). Any appropriate polypropylene can be adopted as the polypropylene. For example, there are given homopolypropylene, block polypropylene, random polypropylene, and the like. As the structure of the homopolypropylene, there are given an isotactic structure, an atactic structure, a syndiotactic structure, and the like.

The above-mentioned base material layer particularly preferably includes a mixture of a low-density polyethylene (LDPE) and a linear, low-density polyethylene (LLDPE). The incorporation of such mixture can provide a surface protective film, which shows a small change over time in rewinding force even when stored in a roll shape, while realizing good workability.

The above-mentioned base material layer may include any appropriate other thermoplastic resin except the polymer obtained from the α-olefin having 2 to 12 carbon atoms and the ethylene-vinyl alcohol copolymer. Only one kind of such thermoplastic resins may be used, or a mixture of two or more kinds thereof may be used.

The above-mentioned base material layer may include any appropriate additive as required. Examples of the additive that can be incorporated into the base material layer include a UV absorbing agent, a thermal stabilizer, a filler, and a lubricant. The kinds, number, and amount of additives to be incorporated into the above-mentioned base material layer can be appropriately set depending on purposes.

Examples of the above-mentioned UV absorbing agent include a benzotriazole-based compound, a benzophenone-based compound, and a benzoate-based compound. Any appropriate content can be adopted as the content of the UV absorbing agent as long as the UV absorbing agent does not bleed out at the time of the forming. The content is representatively 0.01 part by weight to 5 parts by weight with respect to 100 parts by weight of the thermoplastic resin in the base material layer.

Examples of the above-mentioned thermal stabilizer include a hindered amine-based compound, a phosphorus-based compound, and a cyanoacrylate-based compound. Any appropriate content can be adopted as the content of the thermal stabilizer as long as the thermal stabilizer does not bleed out at the time of the forming. The content is representatively 0.01 part by weight to 5 parts by weight with respect to 100 parts by weight of the thermoplastic resin in the base material layer.

Examples of the above-mentioned filler include inorganic fillers such as talc, titanium oxide, calcium carbonate, clay, mica, barium sulfate, whisker, and magnesium hydroxide. The average particle diameter of the filler is preferably 0.1 μm to 10 μm. The content of the filler is preferably 1 part by weight to 200 parts by weight with respect to 100 parts by weight of the thermoplastic resin in the base material layer.

A-2. Back Surface Layer

The thickness of the above-mentioned back surface layer is preferably 1 μm to 15 μm, more preferably 2 μm to 10 μm, still more preferably 2 μm to 8 μm, particularly preferably 2 μm to 5 μm. As long as the thickness of the back surface layer falls within the above-mentioned range, the back surface layer can easily express desired surface roughness. In addition, adverse effects that may be exerted by the mechanical properties of the back surface layer on the mechanical properties of the entirety of the surface protective film of the present invention can be easily suppressed.

The surface of the above-mentioned back surface layer has a ten-point average surface roughness Rz of 1.0 or more, preferably 1.0 to 20, more preferably 1.0 to 10, still more preferably 1.0 to 5.0, particularly preferably 1.0 to 3.0. As long as the ten-point average surface roughness Rz of the surface of the back surface layer falls within the above-mentioned range, a state in which the pressure-sensitive adhesive layer and the back surface layer excessively attach to each other when the surface protective film of the present invention is stored in a roll shape can be effectively suppressed.

The surface of the above-mentioned back surface layer has a surface frictional force of preferably 15 N or less, more preferably 5 N to 15 N, still more preferably 8 N to 13 N. As long as the surface frictional force of the surface of the back surface layer falls within the above-mentioned range, in, for example, the case where metal plates to each of which the surface protective film of the present invention is attached for conveyance are stored while being stacked, a good storage state can be maintained, and an individual metal plate can be easily pulled out upon its use.

The above-mentioned back surface layer preferably includes a back surface treatment agent (A) and a thermoplastic polymer (B).

The back surface treatment agent (A) is preferably a releasing agent which has an aliphatic group having 8 to 30 carbon atoms on a polymer side chain and whose weight-average molecular weight is 10,000 to 1,000,000, and is specifically, for example, a reaction product obtained by performing a reaction such as an isocyanate reaction or an ester reaction between a completely or partially saponified ethylene-vinyl alcohol copolymer or polyvinyl alcohol and a compound having an aliphatic group having 8 to 30 carbon atoms.

More specifically, the back surface treatment agent (A) can be synthesized by performing an isocyanate reaction between the completely or partially saponified ethylene-vinyl alcohol copolymer or polyvinyl alcohol and octyl isocyanate, decyl isocyanate, lauryl isocyanate, stearyl isocyanate, or the like, or by performing an ester reaction between the completely or partially saponified ethylene-vinyl alcohol copolymer or polyvinyl alcohol and lauric acid, stearic acid, or the like. The back surface treatment agent (A) is more preferably a reaction product formed of an ethylene-vinyl alcohol copolymer and an isocyanate compound because the reaction product is excellent in compatibility with the thermoplastic polymer (B).

Any appropriate structure can be adopted as the structure of the above-mentioned ethylene-vinyl alcohol copolymer. The content of a vinyl alcohol structural unit in the above-mentioned ethylene-vinyl alcohol copolymer is preferably 40 mol % to 80 mol %, more preferably 40 mol % to 70 mol %. As long as the content of the vinyl alcohol structural unit in the above-mentioned ethylene-vinyl alcohol copolymer falls within the above-mentioned range, sufficient releasing performance can be expressed, and sufficient compatibility with the thermoplastic polymer (B) can also be expressed. It should be noted that two or more kinds of the above-mentioned ethylene-vinyl alcohol copolymers different from each other in polymerization degree or content of the vinyl alcohol structural unit may be used as a mixture.

The above-mentioned isocyanate compound is preferably stearyl isocyanate from the viewpoints of peeling property and heat resistance.

The above-mentioned thermoplastic polymer (B) preferably includes a homopolymer of an olefin monomer and/or a copolymer of an olefin monomer and a polar monomer. More specifically, examples of the homopolymer include homopolypropylene, and examples of the copolymer include: a block, random, or graft propylene-based polymer using an ethylene component as a copolymer component; a reactor TPO; a low-density, high-density, linear low-density, or very low-density ethylene-based polymer; an ethylene-propylene copolymer; an ethylene-vinyl acetate copolymer; an ethylene-methyl acrylate copolymer; an ethylene-ethyl acrylate copolymer; an ethylene-butyl acrylate copolymer; an ethylene-methacrylate copolymer; and an ethylene-methyl methacrylate copolymer. The thermoplastic polymers (B) may be used alone or in combination.

With regard to the contents of the back surface treatment agent (A) and the thermoplastic polymer (B), the content of the back surface treatment agent (A) is preferably 0.1 part by weight to 20 parts by weight, more preferably 0.5 part by weight to 20 parts by weight with respect to 100 parts by weight of the total of the back surface treatment agent (A) and the thermoplastic polymer (B). As long as the content of the back surface treatment agent (A) with respect to the total of the back surface treatment agent (A) and the thermoplastic polymer (B) falls within the above-mentioned range, sufficient releasing performance can be expressed, and sufficient compatibility with the thermoplastic polymer (B) can also be expressed.

A-3. Pressure-Sensitive Adhesive Layer

The thickness of the above-mentioned pressure-sensitive adhesive layer is preferably 1 μm to 100 μm, more preferably 3 μm to 50 μm, still more preferably 5 μm to 30 μm, particularly preferably 5 μm to 15 μm, most preferably 7 μm to 13 μm.

Any appropriate pressure-sensitive adhesive can be adopted as a pressure-sensitive adhesive that forms the above-mentioned pressure-sensitive adhesive layer. Examples of the above-mentioned pressure-sensitive adhesive include a rubber-based pressure-sensitive adhesive, an acrylic pressure-sensitive adhesive, and a silicone-based pressure-sensitive adhesive.

A thermoplastic pressure-sensitive adhesive may also be used as the above-mentioned pressure-sensitive adhesive. A material for forming the thermoplastic pressure-sensitive adhesive is, for example, a styrene-based elastomer, a polymer obtained from an α-olefin having 2 to 12 carbon atoms, and an acrylic thermoplastic resin. The above-mentioned material is preferably a styrene-based elastomer or a polymer obtained from an α-olefin having 2 to 12 carbon atoms. Those materials may be used alone or in combination.

Specific examples of the above-mentioned styrene-based elastomer include: styrene-based AB-type diblock copolymers such as a styrene-ethylene-butylene copolymer (SEB); styrene-based ABA-type triblock copolymers such as a styrene-butadiene-styrene copolymer (SBS), a hydrogenated product of SBS (styrene-ethylene-butylene-styrene copolymer (SEBS)), a styrene-isoprene-styrene copolymer (SIS), a hydrogenated product of SIS (styrene-ethylene-propylene-styrene copolymer (SEPS)), and a styrene-isobutylene-styrene copolymer (SIBS); styrene-based ABAB-type tetrablock copolymers such as styrene-butadiene-styrene-butadiene (SBSB); styrene-based ABABA-type pentablock copolymers such as styrene-butadiene-styrene-butadiene-styrene (SBSBS); styrene-based multi-block copolymers having six or more of A-B repeat units; and hydrogenated products each obtained by hydrogenating ethylenic double bonds of a styrene-based random copolymer such as a styrene-butadiene rubber (SBR). A commercially available product may also be used as the styrene-based elastomer. The styrene-based elastomers may be used alone, or two or more kinds thereof may be used in combination.

The content of a styrene block structure in the above-mentioned styrene-based block copolymer is preferably 5 wt % to 40 wt %, more preferably 7 wt % to 30 wt %, particularly preferably 9 wt % to 20 wt %. When the content of the styrene block structure is smaller than 5 wt %, an adhesive residue due to an insufficient cohesive strength of the pressure-sensitive adhesive layer is apt to occur. When the content of the styrene block structure is larger than 40 wt %, the pressure-sensitive adhesive layer becomes hard, and hence good adhesion for a rough surface may not be obtained.

When the above-mentioned styrene-based elastomer has an ethylene-butylene block structure, the content of a structural unit derived from butylene in the ethylene-butylene block structure is preferably 50 wt % or more, more preferably 60 wt % or more, particularly preferably 70 wt % or more, most preferably 70 wt % to 90 wt %. As long as the content of the structural unit derived from butylene falls within such range, a pressure-sensitive adhesive layer excellent in wettability and adhesion, and capable of being favorably bonded even to a rough surface can be obtained.

Examples of the above-mentioned α-olefin having 2 to 12 carbon atoms include a homopolymer and a copolymer each obtained by polymerizing at least one kind of α-olefin having 2 to 12 carbon atoms such as ethylene, propylene, or butene. The polymer obtained from the α-olefin having 2 to 12 carbon atoms is preferably polyethylene or polypropylene. Any appropriate polyethylene can be adopted as the polyethylene. For example, there are given a low-density polyethylene (LDPE), a linear, low-density polyethylene (LLDPE), a medium-density polyethylene, and a high-density polyethylene (HDPE). Any appropriate polypropylene can be adopted as the polypropylene. For example, there are given homopolypropylene, block polypropylene, random polypropylene, and the like. As the structure of the homopolypropylene, there are given an isotactic structure, an atactic structure, a syndiotactic structure, and the like.

Examples of the above-mentioned acrylic thermoplastic resin include: a polymethyl methacrylate-polybutyl acrylate-polymethyl methacrylate copolymer (PMMA-PBA-PMMA copolymer); and a PMMA-functional group-containing PBA-PMMA copolymer having carboxylic acid as a functional group in a polybutyl acrylate. A commercially available acrylic thermoplastic resin may be used. The acrylic thermoplastic resins may be used alone or in combination.

The above-mentioned pressure-sensitive adhesive layer can include any other component as required. Examples of the other component include: an olefin-based resin; a silicone-based resin; a liquid acrylic copolymer; a polyethylenimine; a fatty acid amide; a phosphate; and a general additive. The kinds, number, and amount of other components to be incorporated into the above-mentioned pressure-sensitive adhesive layer can be appropriately set depending on purposes. Examples of the above-mentioned additive include: a tackifier; a softening agent; an antioxidant; a hindered amine-based light stabilizer; a UV absorbing agent; and a filler or pigment such as calcium oxide, magnesium oxide, silica, zinc oxide, or titanium oxide.

The compounding of the tackifier is effective in improving an adhesive strength. The compounding amount of the tackifier is suitably determined to be any appropriate compounding amount depending on an adherend in order that the emergence of an adhesive residue problem due to a reduction in cohesive strength may be avoided. In ordinary cases, the amount is preferably 0 part by weight to 40 parts by weight, more preferably 0 part by weight to 30 parts by weight, still more preferably 0 part by weight to 10 parts by weight with respect to 100 parts by weight of the resin material for forming the pressure-sensitive adhesive.

Examples of the tackifier include: petroleum-based resins such as an aliphatic copolymer, an aromatic copolymer, an aliphatic/aromatic copolymer system, and an alicyclic copolymer; coumarone-indene-based resins; terpene-based resins; terpene phenol-based resins; rosin-based resins such as polymerized rosin; (alkyl) phenol-based resins; xylene-based resins; and hydrogenated products of the resins. The tackifiers may be used alone or in combination.

A hydrogenated tackifier such as an “ARKON P-125” manufactured by Arakawa Chemical Industries, Ltd. is preferably used as the tackifier in terms of, for example, peeling property and weatherability. It should be noted that a product commercially available as a blend with an olefin resin or thermoplastic elastomer can also be used as the tackifier.

The compounding of the softening agent is effective in improving the adhesive strength. Examples of the softening agent include a low-molecular-weight diene-based polymer, a polyisobutylene, a hydrogenated polyisoprene, a hydrogenated polybutadiene, and derivatives thereof. Examples of the derivatives include those each having an OH group or COOH group on one of, or each of both of, its terminals. Specific examples of such derivatives include a hydrogenated polybutadiene diol, a hydrogenated polybutadiene monool, a hydrogenated polyisoprene diol, and a hydrogenated polyisoprene monool. A hydrogenated product of a diene-based polymer such as a hydrogenated polybutadiene or a hydrogenated polyisoprene, an olefin-based softening agent, or the like is preferred in order that a rise in adhesion for the adherend may be additionally suppressed. Those softening agents may be used alone or in combination.

The molecular weight of the softening agent can be suitably set to any appropriate value. When the molecular weight of the softening agent is excessively small, the small molecular weight may cause, for example, the transfer of a substance from the pressure-sensitive adhesive layer to the adherend or heavy peeling. On the other hand, when the molecular weight of the softening agent is excessively large, an improving effect on the adhesive strength tends to be poor. Accordingly, the number-average molecular weight of the softening agent is preferably 5,000 to 100,000, more preferably 10,000 to 50,000.

When the softening agent is used, any appropriate amount can be adopted as its addition amount. When the addition amount of the softening agent is excessively large, the amount of an adhesive residue at the time of exposure to high temperatures or outdoors tends to increase. Accordingly, the addition amount is preferably 40 parts by weight or less, more preferably 20 parts by weight or less, still more preferably 10 parts by weight or less with respect to 100 parts by weight of the resin material for forming the pressure-sensitive adhesive. When the addition amount of the softening agent exceeds 40 parts by weight with respect to 100 parts by weight of the resin material for forming the pressure-sensitive adhesive, the adhesive residue under a high-temperature environment or under exposure to outdoors becomes remarkable.

One, or each of both, of the surfaces of the above-mentioned pressure-sensitive adhesive layer may be subjected to a surface treatment as required. Examples of the surface treatment include a corona discharge treatment, a UV irradiation treatment, a flame treatment, a plasma treatment, and a sputter etching treatment.

A-4. Any Other Layer

The surface protective film of the present invention may further have any appropriate other layer as required (not shown). The other layer may be provided at any position except the side of the back surface layer where the base material layer is not placed.

The thickness of the above-mentioned other layer is preferably 1 μm to 15 μm, more preferably 2 μm to 10 μm.

B. Method of Producing Surface Protective Film

The surface protective film of the present invention can be produced by any appropriate method. Examples of the method include: a method involving subjecting the above-mentioned base material layer, the above-mentioned back surface layer, and the above-mentioned pressure-sensitive adhesive layer, and as required, the other layer to co-extrusion (production method 1); a method involving subjecting the above-mentioned base material layer and the above-mentioned back surface layer, and as required, the other layer to co-extrusion to produce a laminated film and applying a material for forming the above-mentioned pressure-sensitive adhesive layer to the side of the laminated film where the back surface layer is not placed (production method 2); a method involving subjecting the above-mentioned base material layer and the above-mentioned back surface layer, and as required, the other layer to co-extrusion to produce a laminated film and applying, to the side of the laminated film where the back surface layer is not placed, an organic solvent application liquid prepared by dissolving the material for forming the above-mentioned pressure-sensitive adhesive layer or an emulsion liquid prepared by water-dispersing the material for forming the above-mentioned pressure-sensitive adhesive layer (production method 3); and a method involving forming each of the above-mentioned base material layer, the above-mentioned back surface layer, and the above-mentioned pressure-sensitive adhesive layer, and as required, the other layer by a calender forming method or the like and attaching these layers with any appropriate adhesive (production method 4).

The above-mentioned co-extrusion can be performed with an extruder and a co-extrusion die in conformity with, for example, an inflation method or a T-die method.

Examples of the above-mentioned application method include methods each involving the use of a bar coater, a gravure coater, a spin coater, a roll coater, a knife coater, or an applicator.

The surface of the pressure-sensitive adhesive layer may be subjected to an easy-adhesion treatment. Examples of the easy-adhesion treatment include a corona discharge treatment, an ITRO treatment (silicification flame treatment), and an anchor coat treatment.

Hereinafter, the present invention is described specifically by way of examples. However, the present invention is by no means limited to these examples. It should be noted that test and evaluation methods in the examples and the like are as described below. In addition, the term “part(s)” means “part(s) by weight.”

(1) Ten-Point Average Surface Roughness Rz

After the surface protective film had been attached to a slide glass, the surface roughness of the back surface layer was measured with an optical profiler NT9100 (manufactured by Veeco) under the conditions “Measurement Type: VSI (Infinite Scan), Objective: 50×, FOV: 2.0×, Modulation Threshold: 0.1%” over a range measuring 64 μm×48 μm for n=3. After the measurement, data analysis was performed under the conditions “Terms Removal: Tilt Only (Plane Fit), Window Filtering: None,” and the average of ten largest values out of the peak-to-valley intervals was determined as the ten-point average surface roughness Rz.

(2) Rewinding Force

The rewinding force of a test sample prepared by winding the surface protective film in a roll shape was measured in conformity with JIS Z0237 (2000) with a rewinding force-measuring apparatus. The total weighted average of the output rewinding forces was defined as a rewinding force. A result of the measurement obtained by using the test sample after storage at 23° C. for 30 days was defined as the “rewinding force A after storage at 23° C.,” and a result of the measurement obtained by using the test sample after storage at 50° C. for 30 days was defined as the “rewinding force B after storage at 50° C.”

Measurement temperature: 23° C. or 50° C.

Width of test piece: 20 mm

Tension speed: 300 mm/min

n=3

(3) Rupture Elongation

Measurement was performed in conformity with JIS Z2307 under the following conditions.

Measurement temperature: 25° C.

Width of test piece: 20 mm

Tension speed: 300 mm/min

Interchuck distance: 50 mm

n=3 for each of the MD direction and the TD direction

A rupture elongation was calculated by determining the length of the test piece when the test piece ruptured.

(4) Elastic Modulus in Tension

Measurement was performed in conformity with JIS K7161 under the following conditions. An elastic modulus in tension was determined by the linear regression of a curve between two specified strains ε₁=1 and ε₂=2.

Measurement temperature: 25° C.

Width of test piece: 20 mm

Tension speed: 300 mm/min

Interchuck distance: 50 mm

n=3 for each of the MD direction and the TD direction

An elastic modulus in tension in the MD direction was represented by E1, and an elastic modulus in tension in the TD direction was represented by E2. The E1 and E2 were each determined in terms of a value per sectional area on the basis of a thickness value obtained by subtracting the thickness of the pressure-sensitive adhesive layer from the actual value for the thickness of the surface protective film.

### Synthesis Example 1

### Synthesis of Back Surface Treatment Agent

100 Parts by weight of an ethylene-vinyl alcohol copolymer (manufactured by KURARAY CO., LTD., trade name: “Eval E-171B,” ethylene structural unit: 44 mol %) and 310 parts by weight of octadecyl isocyanate (manufactured by HODOGAYA CHEMICAL CO., LTD., trade name: “Millionate O”) were dispersed in 2,000 parts by weight of toluene. While the mixture was refluxed for 2 hours, moisture was removed by separation from a refluxing apparatus during the reflux. After that, the remainder was cooled to 40° C., and then 300 parts by weight of dimethyl sulfoxide were added to the cooled product. Octadecyl isocyanate (manufactured by HODOGAYA CHEMICAL CO., LTD., trade name: “Millionate O”) was dropped to the mixture while being stirred so that an equivalent ratio of isocyanate groups to the hydroxyl groups of the ethylene-vinyl alcohol copolymer was 0.7. Then, the mixture was subjected to a reaction at 120° C. for 4 hours. During the reaction, the remaining isocyanate groups in the system were quantified with an infrared spectrophotometer (around 2,260 cm⁻¹), and the time point at which the remaining groups disappeared was defined as an endpoint.

After the termination of the reaction, 340 parts by weight of water were added to the reaction liquid so that the reaction liquid was separated. After the reaction liquid as a toluene layer had been subjected to azeotropic dehydration at 110° C. for 1 hour, the reaction liquid was filtered under pressure at 30° C. with a closed pressure filter (manufactured by TOYO ENGINEERING WORKS, LTD., sterile filter). The resultant filtrate was poured into 5,000 parts by weight of methanol so that a white precipitate was deposited. After having been separated by filtration, the precipitate was washed with methanol, centrifuged, and dried and pulverized. Thus, 363 parts by weight of the target back surface treatment agent were obtained.

The total content of impurities in the resultant back surface treatment agent was 0.4 wt %, and the back surface treatment agent had a weight-average molecular weight of 1.13×10⁵. It should be noted that methods of calculating the total content (wt %) of the impurities in the back surface treatment agent and the weight-average molecular weight of the back surface treatment agent are as described below.

The total content of the impurities in the back surface treatment agent was measured by employing a GPC method. A “TSKgel” manufactured by TOSOH CORPORATION (solvent: tetrahydrofuran, temperature: 40° C., flow rate: 0.6 ml/min, concentration: 1.0 mg/ml, column: Super HZM-H/HZ4000/HZ3000/HZ2000, detector: RI (built in the apparatus)) was used as an apparatus. A ratio represented in terms of percentage of the peak areas of components below a peak valley (local minimum) present at a molecular weight in terms of polystyrene of about 3.0×10³ to the total peak area in the resultant molecular weight distribution chart was defined as the total content.

In addition, the weight-average molecular weight of the back surface treatment agent is the weight-average molecular weight of components having higher molecular weights than a peak valley (local minimum) present at a molecular weight in terms of polystyrene of about 3.0×10³ in a molecular weight distribution chart obtained in the same manner as in the case of the total content of the impurities in the above-mentioned back surface treatment agent.

### Example 1

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 10 parts |
| Example 1) | |
| NOVATEC LV440 (EVA) (manufactured by Japan Polyethylene | 10 parts |
| Corporation, d = 0.936, MFR = 2.0) | |
| NOVATEC LC720 (PE) (manufactured by Japan Polyethylene | 80 parts |
| corporation, d = 0.922, MFR = 9.4) | |

Materials for Forming Base Material Layer:

| | |
|---|---|
| Petrocene 186 (LDPE) (manufactured by TOSOH | 90 parts |
| CORPORATION, d = 0.924, MER = 3) | |
| EXCELLEN CX3007 (LLDPE) (manufactured by Sumitomo | 10 parts |
| Chemical Company, Limited, d = 0.890, MFR = 3.2) | |

Materials for Forming Pressure-Sensitive Adhesive Layer:

| | |
|---|---|
| DYNARON 8600P (SEBS) (manufactured by JSR Corporation, | 82 parts |
| d = 0.90, MFR = 30) | |
| ARKON P-125 (manufactured by Arakawa Chemical | 18 parts |
| Industries, Ltd.) | |

The materials for forming a back surface layer and the materials for forming a base material layer described above were subjected to co-extrusion by a T-die molding method at a die temperature of 200° C. Thus, a laminated film formed of a configuration “back surface layer (thickness: 10 μm)/base material layer (thickness: 100 μm)” was obtained. The materials for forming a pressure-sensitive adhesive layer were applied to the surface of the laminated film on the base material layer side, and were then dried at 80° C. for 1 minute. Thus, a pressure-sensitive adhesive layer (thickness: 10 μm) was formed.

Thus, a surface protective film (1) formed of a configuration “back surface layer (thickness: 10 μm)/base material layer (thickness: 100 μm)/pressure-sensitive adhesive layer (thickness: 10 μm)” was obtained.

Tables 1 and 2 show the details of the surface protective film (1).

In addition, Table 3 shows the results of the evaluation of the surface protective film (1).

### Example 2

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 9 parts |
| Example 1) | |
| NOVATEC LV440 (EVA) (manufactured by Japan | 9 parts |
| Polyethylene Corporation, d = 0.936, MFR = 2.0) | |
| NOVATEC LC720 (PE) (manufactured by Japan Polyethylene | 80 parts |
| Corporation, d = 0.922, MFR = 9.4) | |
| Synthetic silica (manufactured by FUJI SILYSIA | 2 parts |
| CHEMICAL LTD.) (Average particle diameter = 5 μm) | |

Materials for Forming Base Material Layer:

| | |
|---|---|
| Petrocene 186 (LDPE) (manufactured by TOSOH | 85 parts |
| CORPORATION, d = 0.924,MFR = 3) | |
| EXCELLEN CX3007 (LLDPE) (manufactured by Sumitomo | 10 parts |
| Chemical Company, Limited, d = 0.890, MFR = 3.2) | |
| Titanium oxide (white) (manufactured by ISHIHARA SANGYO | 5 parts |
| KAISHA, LTD.) | |

Materials for Forming Pressure-Sensitive Adhesive Layer:

| | |
|---|---|
| DYNARON 8600P (SEBS) (manufactured by JSR Corporation, | 82 parts |
| d = 0.90, MFR = 30) | |
| ARKON P-125 (manufactured by Arakawa Chemical | 18 parts |
| Industries, Ltd. ) | |

The materials for forming aback surface layer, the materials for forming a base material layer, and the materials for forming a pressure-sensitive adhesive layer described above were subjected to co-extrusion by a T-die molding method at a die temperature of 180° C. Thus, a surface protective film (2) formed of a configuration “back surface layer (thickness: 10 μm)/base material layer (thickness: 100 μm)/pressure-sensitive adhesive layer (thickness: 10 μm)” was obtained.

Tables 1 and 2 show the details of the surface protective film (2).

In addition, Table 3 shows the results of the evaluation of the surface protective film (2).

### Example 3

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 9 parts |
| Example 1) | |
| NOVATEC LV440 (EVA) (manufactured by Japan | 9 parts |
| Polyethylene Corporation, d = 0.936, MFR = 2.0) | |
| NOVATEC LC720 (PE) (manufactured by Japan Polyethylene | 80 parts |
| Corporation, d = 0.922, MFR = 9.4) | |
| Synthetic silica (manufactured by FUJI SILYSIA | 2 parts |
| CHEMICAL LTD.) (Average particle diameter = 5 μm) | |

Materials for Forming Base Material Layer:

| | |
|---|---|
| Petrocene 186 (LDPE) (manufactured by TOSOH | 90 parts |
| CORPORATION, d = 0.924,MFR = 3) | |
| EXCELLEN CX3007 (LLDPE) (manufactured by Sumitomo | 5 parts |
| Chemical Company, Limited, d = 0.890, MFR = 3.2) | |
| Titanium oxide (white) (manufactured by ISHIHARA | 5 parts |
| SANGYO KAISHA, LTD.) | |

Materials for Forming Pressure-Sensitive Adhesive Layer:

| | |
|---|---|
| DYNARON 8600P (SEBS) (manufactured by JSR Corporation, | 82 parts |
| d = 0.90, MFR = 30) | |
| ARKON P-125 (manufactured by Arakawa Chemical | 18 parts |
| Industries, Ltd.) | |

The materials for forming aback surface layer, the materials for forming a base material layer, and the materials for forming a pressure-sensitive adhesive layer described above were subjected to co-extrusion by an inflation molding method at a die temperature of 180° C. Thus, a surface protective film (3) formed of a configuration “back surface layer (thickness: 5 μm)/base material layer (thickness: 75 μm)/pressure-sensitive adhesive layer (thickness 10 μm)” was obtained.

Tables 1 and 2 show the details of the surface protective film (3).

In addition, Table 3 shows the results of the evaluation of the surface protective film (3).

### Example 4

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 5 parts |
| Example 1) | |
| NOVATEC LV440 (EVA) (manufactured by Japan | 5.5 parts |
| Polyethylene Corporation, d = 0.936, MER = 2.0) | |
| NOVATEC LC720 (PE) (manufactured by Japan Polyethylene | 89.5 parts |
| Corporation, d = 0.922, MFR = 9.4) | |

Materials for Forming Base Material Layer:

| | |
|---|---|
| Petrocene 186 (LDPE) (manufactured by TOSOH | 100 parts |
| CORPORATION, d = 0.924, MFR = 3) | |

Materials for Forming Pressure-Sensitive Adhesive Layer:

| | |
|---|---|
| TafthrenT1712 (amorphous PP) (manufactured by Sumitomo | 100 parts |
| Chemical Company, Limited, d = 0.86, MFR = 0.5) | |

The materials for forming a back surface layer, the materials for forming a base material layer, and the materials for forming a pressure-sensitive adhesive layer described above were subjected to co-extrusion by a T-die molding method at a die temperature of 180° C. Thus, a surface protective film (4) formed of a configuration “back surface layer (thickness: 10 μm)/base material layer (thickness: 90 μm)/pressure-sensitive adhesive layer (thickness: 7 μm)” was obtained.

Tables 1 and 2 show the details of the surface protective film (4).

In addition, Table 3 shows the results of the evaluation of the surface protective film (4).

### Example 5

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 4 parts |
| Example 1) | |
| NOVATEC LV440 (EVA)(manufactured by Japan | 4.5 parts |
| Polyethylene Corporation, d = 0.936, MFR = 2.0) | |
| NOVATEC LC720 (PE) (manufactured by Japan Polyethylene | 91.5 parts |
| Corporation, d = 0.922, MFR = 9.4) | |

Materials for forming base material layer:

| | |
|---|---|
| Petrocene 186 (LDPE) (manufactured by TOSOH | 90 parts |
| CORPORATION, d = 0.924, MFR = 3) | |
| EXCELLEN CX3007 (LLDPE) (manufactured by Sumitomo | 10 parts |
| Chemical Company, Limited, d = 0.890, MFR = 3.2) | |

Materials for Forming Pressure-Sensitive Adhesive Layer:

| | |
|---|---|
| NOTIO (amorphous PP) (manufactured by MITSUI | 100 parts |
| CHEMICALS, INC., d = 0.866, MFR = 6) | |

The materials for forming aback surface layer, the materials for forming a base material layer, and the materials for forming a pressure-sensitive adhesive layer described above were subjected to co-extrusion by an inflation molding method at a die temperature of 180° C. Thus, a surface protective film (5) formed of a configuration “back surface layer (thickness: 10 μm)/base material layer (thickness: 90 μm)/pressure-sensitive adhesive layer (thickness: 5 μm)” was obtained.

Tables 1 and 2 show the details of the surface protective film (5).

In addition, Table 3 shows the results of the evaluation of the surface protective film (5).

### Example 6

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 8 parts |
| Example 1) | |
| NOVATEC LV440 (EVA) (manufactured by Japan Polyethylene | 5 parts |
| Corporation, d = 0.936, MFR = 2.0) | |
| NOVATEC LC720 (PE) (manufactured by Japan Polyethylene | 87 parts |
| Corporation, d = 0.922, MFR = 9.4) | |

Materials for Forming Base Material Layer:

| | |
|---|---|
| NOVATEC PP BC3F (manufactured by Japan Polypropylene | 100 parts |
| Corporation, d = 0.90, MFR = 8.5) | |

Materials for Forming Pressure-Sensitive Adhesive Layer:

| | |
|---|---|
| ARKON P-125 (manufactured by Arakawa Chemical | 10 parts |
| Industries, Ltd.) | |
| Tafthren T1712 (amorphous PP) (manufactured by Sumitomo | 90 parts |
| Chemical Company, Limited, d = 0.86, MFR = 0.5) | |

The materials for forming a back surface layer and the materials for forming a base material layer described above were subjected to co-extrusion by a T-die molding method at a die temperature of 240° C. Thus, a laminated film formed of a configuration “back surface layer (thickness: 2 μm)/base material layer (thickness: 40 μm)” was obtained. The materials for forming a pressure-sensitive adhesive layer were applied to the surface of the laminated film on the base material layer side, and were then dried at 80° C. for 1 minute. Thus, a pressure-sensitive adhesive layer (thickness: 5 μm) was formed.

Thus, a surface protective film (6) formed of a configuration “back surface layer (thickness: 2 μm)/base material layer (thickness: 40 μm)/pressure-sensitive adhesive layer (thickness: 5 μm)” was obtained.

Tables 1 and 2 show the details of the surface protective film (6).

In addition, Table 3 shows the results of the evaluation of the surface protective film (6).

### Example 7

The following compounds were prepared as materials for forming a back surface layer, materials for forming a base material layer, and materials for forming a pressure-sensitive adhesive layer.

Materials for Forming Back Surface Layer:

| | |
|---|---|
| Back surface treatment agent (synthesized in Synthesis | 4 parts |
| Example 1) | |
| NOVATEC LV440 (EVA) (manufactured by Japan Polyethylene | 10 parts |
| Corporation, d = 0.936, MFR = 2.0) | |
| NOVATEC LC720 (PE) (manufactured by Japan Polyethylene | 86 parts |
| Corporation, d = 0.922, MFR = 9.4) | |

Materials for Forming Base Material Layer:

| | |
|---|---|
| EXCELLEN CX3007 (LLDPE) (manufactured by Sumitomo | 20 parts |
| Chemical Company, Limited, d = 0.890, MFR = 3.2) | |
| NOVATEC PP BC3F (manufactured by Japan Polypropylene | 80 parts |
| Corporation, d = 0.90, MFR = 8.5) | |

Materials for Forming Pressure-Sensitive Adhesive Layer:

| | |
|---|---|
| Tafthren T1712 (amorphous PP) (manufactured by Sumitomo | 100 parts |
| Chemical Company, Limited, d = 0.86, MFR = 0.5) | |

The materials for forming a back surface layer, the materials for forming a base material layer, and the materials for forming a pressure-sensitive adhesive layer described above were subjected to co-extrusion by an inflation molding method at a die temperature of 180° C. Thus, a surface protective film (7) formed of a configuration “back surface layer (thickness: 4 μm)/base material layer (thickness: 50 μm)/pressure-sensitive adhesive layer (thickness: 7 μm)” was obtained.

Tables 1 and 2 show the details of the surface protective film (7).

In addition, Table 3 shows the results of the evaluation of the surface protective film (7).

### Comparative Example 1

The following compounds were prepared as materials for forming a back surface layer, materials for forming a base material layer, and materials for forming a pressure-sensitive adhesive layer.

Materials for Forming Back Surface Layer:

| | |
|---|---|
| Releasing agent (Peeloil 1010, manufactured by Ipposha | 100 parts |
| Oil Industries Co., Ltd.) | |

Materials for Forming Base Material Layer:

| | |
|---|---|
| Petrocene 186 (LDPE) (manufactured by TOSOH | 80 parts |
| CORPORATION, d = 0.924, MFR = 3) | |
| EXCELLEN CX3007 (LLDPE) (manufactured by Sumitomo | 15 parts |
| Chemical Company, Limited, d = 0.890, MFR = 3.2) | |
| Titanium oxide (white) (manufactured by ISHIHARA SANGYO | 5 parts |
| KAISHA LTD.) | |

Materials for Forming Pressure-Sensitive Adhesive Layer:

| | |
|---|---|
| DYNARON 8600P (SEBS) (manufactured by JSR Corporation, | 90 parts |
| d = 0.90, MFR = 30) | |
| ARKON P-125 (manufactured by Arakawa Chemical | 10 parts |
| Industries, Ltd. ) | |

The above-mentioned materials for forming a base material layer were subjected to extrusion molding by a T-die molding method at a die temperature of 180° C. Thus, a film was obtained. The releasing agent as the above-mentioned material for forming a back surface layer was applied to one surface of the resultant film. Thus, a laminated film formed of a configuration “back surface layer (thickness: 5 μm)/base material layer (thickness: 90 μm)” was obtained. The materials for forming a pressure-sensitive adhesive layer were applied to the surface of the laminated film on the base material layer side, and were then dried at 80° C. for 1 minute. Thus, a pressure-sensitive adhesive layer (thickness: 10 μm) was formed.

Thus, a surface protective film (C1) formed of a configuration “back surface layer (thickness: 5 μm)/base material layer (thickness: 90 μm)/pressure-sensitive adhesive layer (thickness: 10 μm)” was obtained.

Tables 1 and 2 show the details of the surface protective film (C1).

In addition, Table 3 shows the results of the evaluation of the surface protective film (C1).

### Comparative Example 2

The following compounds were prepared as materials for forming a base material layer and materials for forming a pressure-sensitive adhesive layer.

Materials for Forming Base Material Layer

| | |
|---|---|
| NOVATEC PP BC3F (manufactured by Japan Polypropylene | 100 parts |
| Corporation, d = 0.90, MFR = 8.5) | |

Materials for Forming Pressure-Sensitive Adhesive Layer:

| | |
|---|---|
| NOTIO (amorphous PP) (manufactured by MITSUI | 100 parts |
| CHEMICALS, INC., d = 0.866, MFR = 6) | |

The above-mentioned materials for forming a base material layer were subjected to extrusion molding by a T-die molding method at a die temperature of 240° C. Thus, a film (thickness: 110 μm) was obtained. The materials for forming a pressure-sensitive adhesive layer were applied to one surface of the film, and were then dried at 80° C. for 1 minute. Thus, a pressure-sensitive adhesive layer (thickness: 10 μm) was formed.

Thus, a surface protective film (C2) formed of a configuration “base material layer (thickness: 110 μm)/pressure-sensitive adhesive layer (thickness: 10 μm)” was obtained.

Tables 1 and 2 show the details of the surface protective film (C2).

In addition, Table 3 shows the results of the evaluation of the surface protective film (C2).

### Comparative Example 3

The following compounds were prepared as materials for forming a base material layer and materials for forming a pressure-sensitive adhesive layer.

Materials for Forming Base Material Layer:

| | |
|---|---|
| Polyvinyl chloride resin (having an average | 100 parts |
| polymerization degree of 1,100) | |
| Dioctyl phthalate | 35 parts |
| Ba—Zn-based composite stabilizer | 2 parts |

Materials for Forming Pressure-Sensitive Adhesive Layer:

| | |
|---|---|
| DYNARON 8600P (SEBS) (manufactured by JSR Corporation, | 82 parts |
| d = 0.90, MFR = 30) | |
| ARKON P-125 (manufactured by Arakawa Chemical | 18 parts |
| Industries, Ltd. ) | |

The above-mentioned materials for forming a base material layer were rolled by a calendar method. Thus, a soft vinyl chloride resin film (thickness: 120 μm) was obtained. The materials for forming a pressure-sensitive adhesive layer were applied to one surface of the film, and were then dried at 80° C. for 1 minute. Thus, a pressure-sensitive adhesive layer (thickness: 15 μm) was formed.

Thus, a surface protective film (C3) formed of a configuration “base material layer (thickness: 120 μm)/pressure-sensitive adhesive layer (thickness: 15 μm)” was obtained.

Tables 1 and 2 show the details of the surface protective film (C3).

In addition, Table 3 shows the results of the evaluation of the surface protective film (C3).

TABLE 1

| | Thickness (μm) | | | |
|---|---|---|---|---|
| | Back surface layer/base | Content of back | | Main component of |
| | material | surface treatment | Composition of | pressure-sensitive |
| | layer/pressure-sensitive | agent in back | base material | adhesive |
| | adhesive layer | surface layer (wt %) | layer | layer |
| Example 1 | 10/100/10 | 10 | LDPE + LLDPE | SEBS |
| Example 2 | 10/100/10 | 9 | LDPE + LLDPE + TiO₂ | SEBS |
| Example 3 | 5/75/10 | 9 | LDPE + LLDPE + TiO₂ | SEBS |
| Example 4 | 10/90/7 | 5 | LDPE | PP |
| Example 5 | 10/90/5 | 4 | LDPE + LLDPE | PP |
| Example 6 | 2/40/5 | 8 | PP | PP |
| Example 7 | 4/50/7 | 4 | LLDPE + PP | PP |
| Comparative | 5 (applied)/90/10 | 5 μm of releasing | LDPE + LLDPE + TiO₂ | SEBS |
| Example 1 | | agent is applied | | |
| Comparative | —/110/10 | 0 | PP | PP |
| Example 2 | | | | |
| Comparative | —/120/15 | 0 | Soft vinyl | SEBS |
| Example 3 | | | chloride resin | |

TABLE 2

| | Back surface layer | | | | Base material layer | | | | Pressure-sensitive | | |
|---|---|---|---|---|---|---|---|---|---|---|---|
| | Back surface | LV | LC | Synthetic | Petrocene | CX | | | adhesive layer | | |
| | treatment agent | 440 | 720 | silica | 186 | 3007 | TiO₂ | PP | 8600P | P-125 | PP |
| Example 1 | 10 | 10 | 80 | — | 90 | 10 | — | — | 82 | 18 | — |
| Example 2 | 9 | 9 | 80 | 2 | 85 | 10 | 5 | — | 82 | 18 | — |
| Example 3 | 9 | 9 | 80 | 2 | 90 | 5 | 5 | — | 82 | 18 | — |
| Example 4 | 5 | 5.5 | 89.5 | — | 100 | — | — | — | — | — | 100 |
| Example 5 | 4 | 4.5 | 91.5 | — | 90 | 10 | — | — | — | — | 100 |
| Example 6 | 8 | 5 | 87 | — | — | — | — | 100 | — | 10 | 90 |
| Example 7 | 4 | 10 | 86 | — | — | 20 | — | 80 | — | — | 100 |

| | | | | | | | | |
|---|---|---|---|---|---|---|---|---|
| Comparative | Peeloil 1010 | 80 | 15 | 5 | — | 90 | 10 | — |
| Example 1 | | | | | | | | |

| | | | | | |
|---|---|---|---|---|---|
| Comparative | None | PP | — | — | 100 |
| Example 2 | | | | | |
| Comparative | None | Soft vinyl chloride resin | 82 | 18 | — |
| Example 3 | | | | | |

TABLE 3

| | Rewinding force 0.3 m/min | | | | | | Rupture | | | |
|---|---|---|---|---|---|---|---|---|---|---|
| | 23° C. | 50° C. | Ratio | Elastic modulus in tension | | | elongation | | Surface | Surface |
| | 30 days | 30 days | 50° C./23° C. | MD | TD | MD + TD | MD | TD | frictional | roughness |
| | (N/20 mm) | (N/20 mm) | 30 days | (N/mm²) | (N/mm²) | (N/mm²) | (%) | (%) | force (N) | Rz |
| Example 1 | 0.30 | 0.48 | 1.6 | 171 | 190 | 361 | 645 | 823 | 11.1 | 2.1 |
| Example 2 | 0.27 | 0.42 | 1.6 | 168 | 192 | 359 | 550 | 832 | 10.4 | 2.3 |
| Example 3 | 0.30 | 0.57 | 1.9 | 143 | 178 | 321 | 547 | 728 | 10.9 | 2.4 |
| Example 4 | 0.45 | 0.60 | 1.3 | — | — | — | — | — | — | 1.7 |
| Example 5 | 0.52 | 0.94 | 1.8 | — | — | — | — | — | — | 1.6 |
| Example 6 | 0.60 | 0.80 | 1.3 | 811 | 758 | 1,569 | 536 | 588 | 10.5 | 2.0 |
| Example 7 | 0.40 | 0.50 | 1.3 | 779 | 706 | 1,485 | 699 | 775 | 12.1 | 2.5 |
| Comparative | 1.50 | 3.20 | 2.1 | 119 | 131 | 250 | 594 | 881 | 17.1 | 0.8 |
| Example 1 | | | | | | | | | | |
| Comparative | 2.30 | 2.50 | 1.1 | 195 | 212 | 407 | 510 | 746 | 17.5 | 0.8 |
| Example 2 | | | | | | | | | | |
| Comparative | 0.30 | 1.19 | 4.0 | 243 | 242 | 485.00 | 313 | 391 | 8.3 | 0.7 |
| Example 3 | | | | | | | | | | |

As is apparent from Tables 1, 2, and 3, the surface protective film of the present invention not only maintains its adhesion for an adherend but also shows a small change over time in rewinding force even when stored in a roll shape.

The surface protective film of the present invention can be effectively utilized in the prevention of a flaw or dirt that arises at the time of the working or conveyance of an adherend such as a metal plate, a coated steel plate, or an optical film by being attached to the adherend.

What is claimed is:

1. A surface protective film, comprising:
a back surface layer;
a base material layer; and
a pressure-sensitive adhesive layer in the stated order, wherein:
a surface of the back surface layer has a ten-point average surface roughness Rz of 1.0 or more;
a rewinding force A after storage at 23° C. is 1.0 N/20 mm or less; and
a ratio B/A of a rewinding force B after storage at 50° C. to the rewinding force A after the storage at 23° C. is 1.0 to 2.0.

2. A surface protective film according to claim 1, wherein a rupture elongation in each of an MD direction and a TD direction is 350% to 850%.

3. A surface protective film according to claim 1, wherein an elastic modulus in tension in each of an MD direction and a TD direction is 500 N/mm² to 900 N/mm².

4. A surface protective film according to claim 1, wherein a total of an elastic modulus in tension in an MD direction and an elastic modulus in tension in a TD direction is 270 N/mm² to 450 N/mm².

5. A surface protective film according to claim 1, wherein the base material layer includes at least one kind selected from the group consisting of a polymer obtained from an α-olefin having 2 to 12 carbon atoms and an ethylene-vinyl alcohol copolymer.

6. A surface protective film according to claim 1, wherein the surface of the back surface layer has a surface frictional force of 15 N or less.

7. A surface protective film according to claim 1, wherein the pressure-sensitive adhesive layer includes a styrene-based elastomer.

8. A surface protective film according to claim 1, wherein the pressure-sensitive adhesive layer includes a polymer obtained from an α-olefin having 2 to 12 carbon atoms.
